(19) United States
(12) Patent Application Publication
(10) Pub. No.: US 2014/0017598 A1
(43) Pub. Date: Jan. 16, 2014

(54) FUEL CELL

(71) Applicant: MURATA MANUFACTURING CO., LTD., Nagaokakyo-Shi (JP)

(72) Inventor: Hideaki Nakai, Nagaokakyo-Shi (JP)

(73) Assignee: MURATA MANUFACTURING CO., LTD., Nagaokakyo-Shi (JP)

(21) Appl. No.: 14/031,794

(22) Filed: Sep. 19, 2013

Related U.S. Application Data
(63) Continuation of application No. PCT/JP2012/057183, filed on Mar. 21, 2012.

(30) Foreign Application Priority Data
Mar. 25, 2011 (JP) 2011-067327

(51) Int. Cl. H01M 8/02

(52) U.S. Cl. CPC H01M 8/0258
USPC 429/482

(57) ABSTRACT

Provided is a solid oxide fuel cell capable of achieving high power generation efficiency. A first separator is arranged on an oxidant gas electrode. In the first separator, an oxidant gas channel for supplying an oxidant gas to the oxidant gas electrode is formed. A second separator body is arranged on a fuel electrode In the second separator, a fuel gas channel for supplying a fuel gas to the fuel electrode is formed. The first separator is configured such that the width of the oxidant gas channel decreases stepwise or continuously with distance from the oxidant gas electrode. The second separator is configured such that the width of the fuel gas channel decreases stepwise or continuously with distance from the fuel electrode.

This is a continuation of application Serial No. PCT/JP2012/057183, filed Mar. 21, 2012, the entire contents of which are incorporated herein by reference.

### TECHNICAL FIELD

The present invention relates to a fuel cell. In particular, the present invention relates to a solid oxide fuel cell.

### BACKGROUND ART

In recent years, attention to fuel cells as a new energy source has been increased. Examples of fuel cells include solid oxide fuel cells (SOFC), molten carbonate fuel cell, phosphoric acid fuel cells and polymer electrolyte fuel cells. Among these fuel cells, solid oxide fuel cells do not necessarily require the use of a liquid component and can be internally modified when a hydrocarbon fuel is used. Therefore, research and development on solid oxide fuel cells has been vigorously conducted.

For example, Patent Document 1 discloses a solid oxide fuel cell 100 shown in FIG. 8. The solid oxide fuel cell 100 includes two power generating elements 101a and 101b. The power generating elements 101a and 101b are held between separators 102a and 102b and 102c. A plurality of oxidant gas channels 103a and 103b are formed on a surface of the separator 102a on the power generating element 101a side and a surface of the separator 102b on the power generating element 101b side. On the other hand, a plurality of fuel gas channels 104a and 104b are formed on a surface of the separator 102b on the power generating element 101a side and a surface of the separator 102c on the power generating element 101b side. A plurality of oxidant gas channels 103a and 103b and a plurality of fuel gas channels 104a and 104b extend in mutually orthogonal directions. The cross section of each of a plurality of oxidant gas channels 103a and 103b and a plurality of fuel gas channels 104a and 104b is substantially rectangular.

In the solid oxide fuel cell 100, an oxidant gas is supplied to the power generating elements 101a and 101b via a plurality of oxidant gas channels 103a and 103b. A fuel gas is supplied to the power generating elements 101a and 101b via a plurality of fuel gas channels 104a and 104b. In this way, power is generated.

### PRIOR ART DOCUMENTS

### Patent Documents

Patent Document 1: JP 2004-39573 A

### DISCLOSURE OF THE INVENTION

### Problem to be Solved by the Invention

In a solid oxide fuel cell 100, separators 102a to 102c tend to be damaged when the supply pressure of an oxidant gas and fuel gas is increased. Therefore, it is difficult to enhance power generation efficiency by increasing the supply pressure of an oxidant gas and fuel gas.

The present invention has been devised in view of the situation described above, and an object of the present invention is to provide a solid oxide fuel cell capable of achieving high power generation efficiency.

### Means for Solving the Problem

A fuel cell according to the present invention includes a power generating element, a first separator and a second separator. The power generating element has a solid oxide electrolyte layer, a fuel electrode and an air electrode. The fuel electrode is arranged on one principal surface of the solid oxide electrolyte layer. The air electrode is arranged on the other principal surface of the solid oxide electrolyte layer. The first separator is arranged on the air electrode. In the first separator, an oxidant gas channel for supplying an oxidant gas to the air electrode is formed. The second separator is arranged on the fuel electrode. In the second separator, a fuel gas channel for supplying a fuel gas to the fuel electrode is formed. The first separator is configured such that the width of the oxidant gas channel decreases stepwise or continuously with distance from the air electrode. The second separator is configured such that the width of the fuel gas channel decreases stepwise or continuously with distance from the fuel electrode.

In a specific aspect of the fuel cell according to the present invention, the first separator has linear projections which divide the oxidant gas channel into a plurality of partitions in the width direction. The second separator has linear projections which divide the fuel gas channel into a plurality of partitions in the width direction.

### Advantageous Effect of the Invention

According to the present invention, a solid oxide fuel cell capable of achieving high power generation efficiency can be provided.

### BRIEF EXPLANATION OF DRAWINGS

FIG. 1 is a schematic exploded perspective view of a solid oxide fuel cell according to a first embodiment,

FIG. 2 is a schematic sectional view, along y and z directions, of the solid oxide fuel cell according to the first embodiment.

FIG. 3 is a schematic sectional view, along x and z directions, of the solid oxide fuel cell according to the first embodiment.

FIG. 4 is a schematic sectional view, along y and z directions, of a part of a solid oxide fuel cell according to a second embodiment.

FIG. 5 is a schematic sectional view, along x and z directions, of a part of the solid oxide fuel cell according the second embodiment.

FIG. 6 is a schematic sectional view, along y and z directions, of a part of a solid oxide fuel cell according to a third embodiment.

FIG. 7 is a schematic sectional view, along x and z directions, of a part of the solid oxide fuel cell according to the third embodiment.

FIG. 8 is a schematic exploded perspective view of a solid oxide fuel cell described in Patent Document 1.

### CARRYING OUT THE INVENTION

One example of a preferred embodiment of carrying out the present invention will be described below. It is to be noted that the embodiments described below are merely illustrative. The present invention is in no way limited to the embodiments described below.

In each drawing, members having substantially the same function are denoted by the same symbols. The drawings are schematically described, and the ratio of dimensions, etc., of an object drawn in the drawing may be different from the ratio of dimensions, etc., of the actual object. The dimension ratio, etc., of an object may be different between drawings. A specific dimension ratio of an object should be inferred by considering the descriptions below.

### First Embodiment

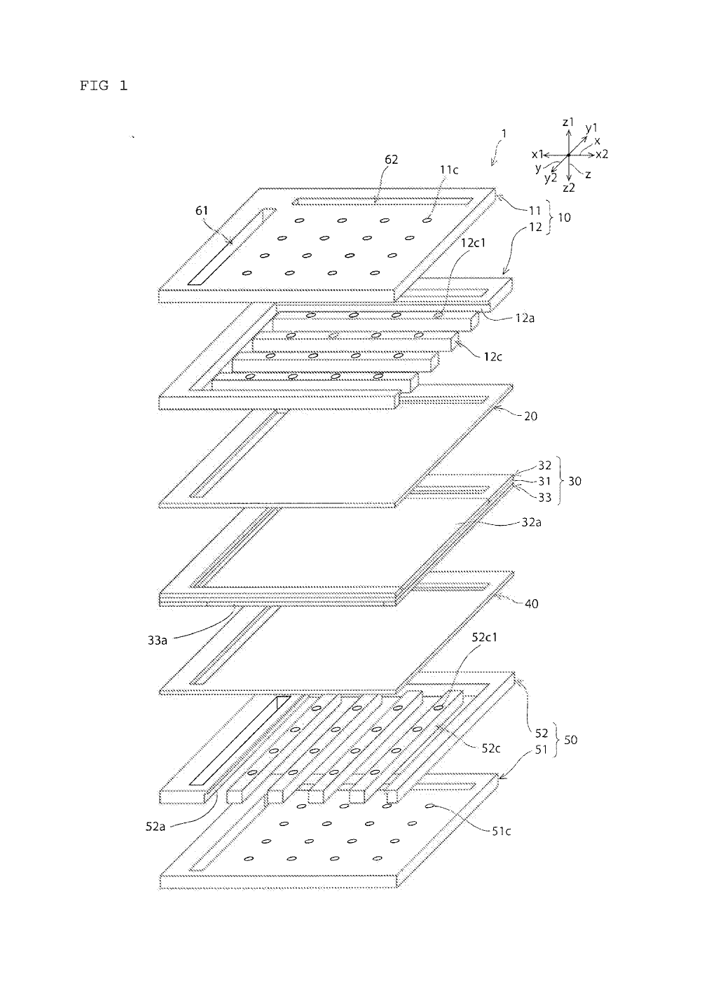

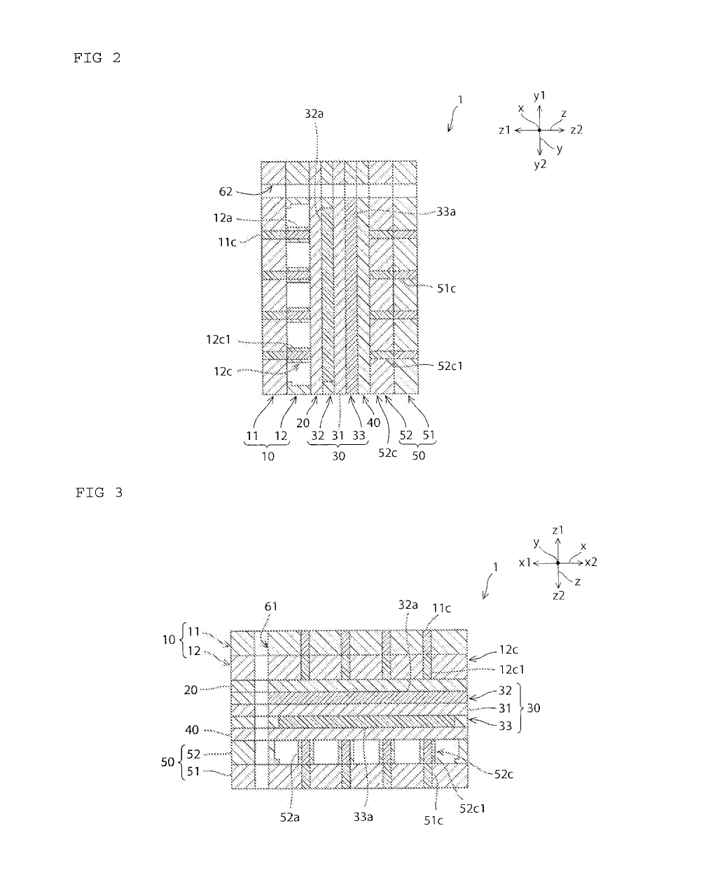

FIG. 1 is a schematic exploded perspective view of a fuel cell according to a first embodiment. FIG. 2 is a schematic sectional view, along y and z directions, of the fuel cell according to the first embodiment. FIG. 3 is a schematic sectional view, along x and z directions, of the fuel cell according to the first embodiment.

As shown in FIGS. 1 to 3, a solid oxide fuel cell 1 according to the first embodiment includes a first separator 10, a first porous body 20, a power generating element 30, a second porous body 40 and a second separator 50. In the solid oxide fuel cell 1, the first separator 10, the first porous body 20, the power generating element 30, the second porous body 40 and the second separator 50 are laminated in this order.

The solid oxide fuel cell 1 of the present embodiment include only one laminated body of the first and second porous bodies 20 and 40 and the power generating element 30. However, the present invention is not limited to this configuration. For example, the fuel cell of the present invention may include a plurality of laminated bodies of first and second porous bodies and a power generating element. In this case, adjacent laminated bodies are isolated from each other by a separator.

Power Generating Element 30

The power generating element 30 is a portion where an oxidant gas supplied from an oxidant gas channel (manifold for oxidant gas) 61 and a fuel gas supplied from a fuel gas channel (manifold for fuel gas) 62 react with each other to generate power. The oxidant gas can be formed from, for example, an oxygen-containing gas such as air or oxygen gas, etc. The fuel gas may be a gas containing a hydrogen gas, and a hydrocarbon gas such as a carbon monoxide gas, etc.

Solid Oxide Electrolyte Layer 31

The power generating element 30 includes a solid oxide electrolyte layer 31. The solid oxide electrolyte layer 31 is preferably one having high ionic conductivity. The solid oxide electrolyte layer 31 can be formed from, for example, stabilized zirconia or partially stabilized zirconia. Specific examples of stabilized zirconia include 10 mol % yttria stabilized zirconia (10YSZ) and 11 mol % scandia stabilized zirconia (11ScSZ). Specific examples of partially stabilized zirconia include 3 mol % yttria stabilized zirconia (3YSZ). The solid oxide electrolyte layer 31 can also be formed from, for example, a ceria-based oxide doped with Sm, Gd and the like, or a perovskite type oxide, such as La_{0.8}Sr_{0.2}Ga_{0.8}Mg_{0.2}O_{(3-δ)}, which has LaGaO₃ as a base and in which La and Ga are partially substituted with Sr and Mg, respectively.

The solid oxide electrolyte layer 31 is held between an air electrode layer 32 and a fuel electrode layer 33. That is, the air electrode layer 32 is formed on one principal surface of the solid oxide electrolyte layer 31, and the fuel electrode layer 33 is formed on the other principal surface.

Air Electrode Layer 32

The air electrode layer 32 has an air electrode 32a, The air electrode 32a is a cathode. In the air electrode 32a, oxygen captures electrons to form oxygen ions. The air electrode 32a is preferably one that is porous, has a high conductivity and is resistant to a solid-solid reaction with the solid oxide electrolyte layer 31 etc. at a high temperature. The air electrode 32a can be formed from, for example, scandia stabilized zirconia (ScSZ), indium oxide doped with Sn, a PrCoO₃-based oxide, a LaCoO₃-based oxide or a LaMnO₃-based oxide. Specific examples of the LaMnO₃-based oxide include La_{0.8}Sr_{0.2}MnO₃ (common name: LSM), L_{0.8}Sr_{0.2}Co_{0.2}Fe_{0.8}O₃ (common name: LSCF) and La_{0.5}Ca_{0.4}MnO₃ (common name: LCM). The air electrode 32a may be formed of a mixed material obtained by mixing two or more of the above-described materials.

Fuel Electrode Layer 33

The fuel electrode layer 33 has a fuel electrode 33a. The fuel electrode 33a is an anode. In the fuel electrode 33a, oxygen ions and a fuel gas react with each other to release electrons. The fuel electrode 33a is preferably one that is porous, has high electron conductivity and is resistant to a solid-solid reaction with the solid oxide electrolyte layer 31 etc, at a high temperature. The fuel electrode 33a can be formed from, for example, NiO, a porous cermet of yttria stabilized zirconia (YSZ)/nickel metal or a porous cermet of scandia stabilized zirconia (ScSZ)/nickel metal. The fuel electrode layer 33 may be formed of a mixed material obtained by mixing two or more of the above-described materials.

First Separator 10

The first separator 10 including a first separator body 11 and a first channel forming member 12 is arranged on the air electrode layer 32 of the power generating element 30. In the first separator 10, an oxidant gas channel 12a for supplying an oxidant gas to the air electrode 32a is formed. The oxidant gas channel 12a extends toward the x2 side from the x1 side in the x direction from a manifold for oxidant gas 61. The oxidant gas channel 12a is divided into a plurality of partitions in the y direction, i.e. the width direction of the oxidant gas channel 12a, by a plurality of linear projections 12c extending along the x direction.

The materials of the first separator body 11 and the first channel forming member 12 are not particularly limited. Each of the first separator body 11 and the first channel forming member 12 can be formed from, for example, stabilized zirconia such as yttria stabilized zirconia, or partially stabilized zirconia. Each of the first separator body 11 and the first channel forming member 12 can also be formed from, for example, a conductive ceramic such as lanthanum chromite or strontium titanate containing a rare earth metal, or an insulating ceramic such as alumina or zirconium silicate.

A plurality of via hole electrodes 12c1 are embedded in each of a plurality of linear projections 12c. A plurality of via hole electrodes 12c1 are formed so as to extend through a plurality of linear projections 12c in a z direction. In the first separator body 11, a plurality of via hole electrodes 11c are formed at positions corresponding to a plurality of via hole electrodes 12c1. A plurality of via hole electrodes 11c are formed so as to extend through the first separator body 11. The plurality of via hole electrodes 11c and via hole electrodes 12c1 form a plurality of via hole electrodes extending from a surface of the linear projection 12c on a side opposite to the first separator body 11 to a surface of the first separator body 11 on a side opposite to the linear projection 12c.

The materials of the via hole electrode 11c and the via hole electrode 12c1 are not particularly limited. Each of the via hole electrode 11c and the via hole electrode 12c1 can be formed from, for example, an Ag—Pd alloy, an Ag—Pt alloy, lanthanum chromite (LaCrO₃) containing an alkali earth metal, lanthanum ferrate (LaFeO₃), or lanthanum strontium manganite (LSM).

Second Separator 50

The second separator 50 including a second separator body 51 and a second channel forming member 52 is arranged on the fuel electrode layer 33 of the power generating element 30. In the second separator 50, a fuel gas channel 52a for supplying a fuel gas to the fuel electrode 33a is formed. The fuel gas channel 52a extends toward the y2 side from the y1 side in the y direction from a manifold for fuel gas 62. The fuel gas channel 52a is divided into a plurality of partitions in the x direction, i.e. the width direction of the fuel gas channel 52a, by a plurality of linear projections 52c extending along the y direction.

The materials of the second separator body 51 and the second channel forming member 52 are not particularly limited. Each of the second separator body 51 and the second channel forming member 52 can be formed from, for example, stabilized zirconia or partially stabilized zirconia. Each of the second separator body 51 and the second channel forming member 52 can also be formed from, for example, a conductive ceramic such as lanthanum chromite or strontium titanate containing a rare earth metal, or an insulating ceramic such as alumina or zirconium silicate.

A plurality of via hole electrodes 5201 are embedded in each of a plurality of linear projections 52c. The plurality of via hole electrodes 52c1 are formed so as to extend through a plurality of linear projections 52c in a z direction. In the second separator body 51, a plurality of via hole electrodes 51c are formed at positions corresponding to a plurality of via hole electrodes 52c1. The plurality of via hole electrodes 51c are formed so as to extend through the second separator body 51. The plurality of via hole electrodes 51c and via hole electrodes 52c1 form a plurality of via hole electrodes extending from a surface of the linear projection 52c on a side opposite to the second separator body 51 to a surface of the second separator body 51 on a side opposite to the linear projection 52c.

The materials of the via hole electrode 51c and the via hole electrode 52c1 are not particularly limited. Each of the via hole electrode 51c and the via hole electrode 52c1 can be formed from, for example, an Ag—Pd alloy, an Ag—Pt alloy, a nickel metal, an yttria stabilized zirconia (YSZ)/nickel metal or a scandia stabilized zirconia (ScSZ)/nickel metal.

First Porous Body 20 and Second Porous Body 40

The first porous body 20 is arranged between the linear projection 12c and the air electrode 32a. The first porous body 20 is formed so as to cover a portion facing the oxidant gas channel 12a in the air electrode 32a. Specifically, the first porous body 20 in this embodiment is formed so as to cover substantially the whole of the air electrode 32a.

An oxidant gas supplied from the oxidant gas channel 12a passes toward the air electrode 32a side while diffusing in the first porous body 20. Therefore, an oxidant gas can be supplied to the air electrode 32a with high uniformity.

On the other hand, a second porous body 40 is arranged between the linear projection 52c and the fuel electrode 33a. The second porous body 40 is formed so as to cover a portion facing the fuel gas channel 52a in the fuel electrode 33a. Specifically, the second porous body 40 in this embodiment, is formed so as to cover substantially the whole of the fuel electrode 33a.

A fuel gas supplied from the fuel gas channel 52a passes toward the fuel electrode 33a side while diffusing in the second porous body 40. Therefore, a fuel gas can be supplied to the fuel electrode 33a with high uniformity.

The materials of the first and second porous bodies 20 and 40 are not particularly limited. In this embodiment, each of the first and second porous materials 20 and 40 is formed of a conductive member. Specifically, the first porous body 20 in this embodiment, is formed of the same material as that of the air electrode 32a. The second porous body 40 is formed of the same material as that of the fuel electrode 33a. Therefore, the air electrode 32a is electrically connected to the via hole electrodes 12c1 and 11c through the first porous body 20. The fuel electrode 33a is electrically connected to the via hole electrodes 52c1 and 51c through the second porous body 40.

The first and second porous bodies 20 and 40 are not essential components in the present invention. Therefore, the first and second porous bodies 20 and 40 may not be present.

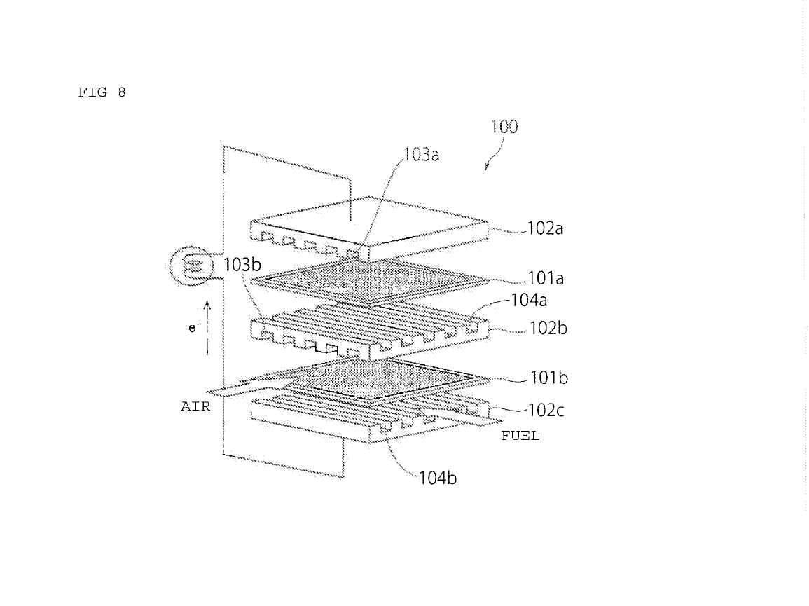

In the solid oxide fuel cell 100 shown in FIG. 8, the cross section of each of a plurality of oxidant gas channels 103a and 103b and a plurality of fuel gas channels 104a and 104b is substantially rectangular. Therefore, stress in the solid oxide fuel cell 100 is concentrated on areas near the corners of the oxidant gas channels 103a and 103b and the fuel gas channels 104a and 104b of the separators 102a to 102c when the supply pressure of an oxidant gas and fuel gas is increased. Therefore, the separators 102a to 102c may be cracked when the supply pressure of an oxidant gas and fuel gas is increased.

When the solid oxide fuel cell 100 is prepared by integral firing, stress caused by a difference in shrinkage behavior between the power generating elements 101a and 101b and the separators 102a to 102c during firing is concentrated on areas near the corners of the oxidant gas channels 103a and 103b and the fuel gas channels 104a and 104b of the separators 102a to 102c. Therefore, the separators 102a to 102c may be cracked during integral firing.

In contrast, the first separator 10 in this embodiment is configured such that the width, along the y direction, of the oxidant gas channel 12a decreases stepwise with distance from the air electrode 32a (toward the z1 side) as shown in FIG. 2. The second separator 50 is configured such that the width, along the x direction, of the fuel gas channel 52a decreases stepwise with distance from the fuel electrode 33a (toward the z2 side) as shown in FIG. 3. That is, level difference structures are formed on the side walls of the channels 12a and 52a.

Therefore, stress caused by the supply pressure of the oxidant gas and fuel gas is applied dispersedly to the separators 10 and 50 even when the supply pressure of an oxidant gas and fuel gas is increased. Accordingly, in the solid oxide fuel cell 1, the separators 10 and 50 are hard to crack, and the supply pressure of an oxidant gas and fuel gas can be increased. Further, the separators 10 and 50 are hard to crack during power generation, so that power can be generated with stability. Therefore, high power generation efficiency can be achieved.

Stress caused by a difference in shrinkage behavior between the separators 10 and 50 and the power generating element 30 during integral firing is also applied dispersedly to the separators 10 and 50. Therefore, the separators 10 and 50 are hard to crack, so that the solid oxide fuel cell 1 can be stably produced with a high yield.

The method for forming the oxidant gas channel 12a and fuel gas channel 52a having a shape as in this embodiment is exemplified by, for example, a method in which a green sheet in which a small size opening is formed is laminated on a green sheet in which an opening having a large size is formed, thereby forming a laminated body for forming portions of the first channel forming member 12 other than the linear projections 12c, and the laminated body is fired.

Other examples of preferred embodiments of carrying out the present invention will be described below. In the descriptions below, members having substantially the same functions as those in the first embodiment are denoted by the same symbols, and explanations thereof are omitted.

### Second Embodiment

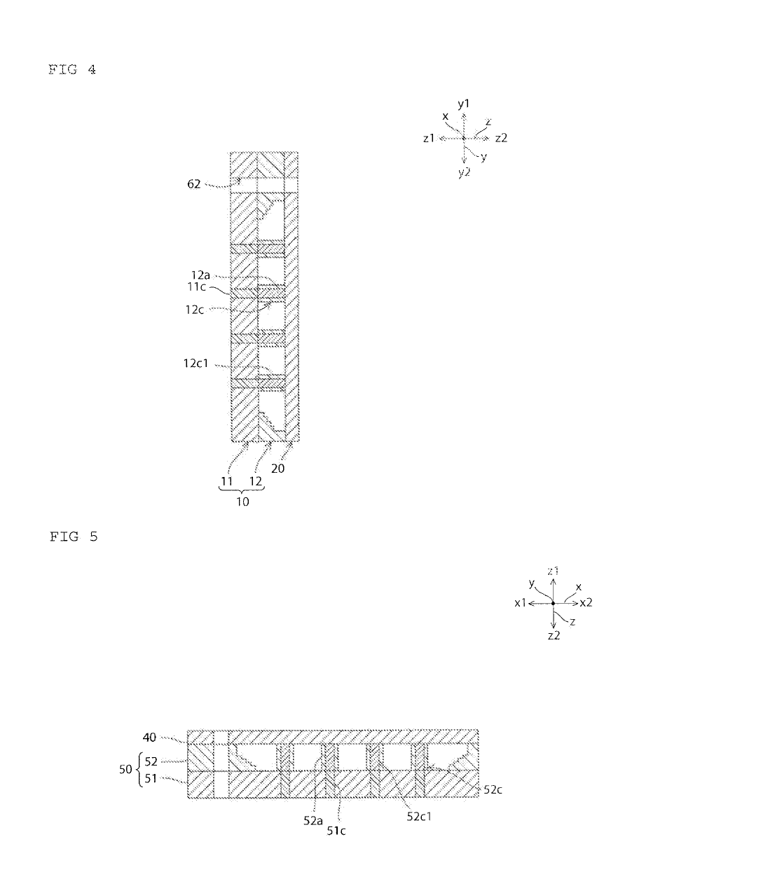

FIG. 4 is a schematic sectional view, along y and z directions, of a part of a fuel cell according to the second embodiment. FIG. 5 is a schematic sectional view, along x and z directions, of a part of the fuel cell according the second embodiment. In FIGS. 4 and 5, the power generating element 30, the second porous body 40 and the second separator 50 are omitted because they are substantially the same as those of the solid oxide fuel cell 1 according to the first embodiment.

In the first embodiment, described was a case where the separators 10 and 50 are configured such that the width of each of the oxidant gas channel 12a and the fuel gas channel 52a decreases in one step. However, the present invention is not limited to this configuration.

For example, as shown in FIG. 4, the first separator 10 is configured such that the width of the oxidant gas channel 12a decreases in multiple steps. As shown in FIG. 5, for instance, the second separator 50 is configured such that the width of the fuel gas channel 52a decreases in multiple steps. By doing so, a situation in which stress is concentrated on specific areas of the separators 10 and 50 can be more effectively suppressed. Therefore, the separators 10 and 50 are hard to crack, so that higher power generation efficiency can be achieved, and a higher yield can be achieved.

When there are too may portions of the channels 12a and 52a which are different in width, production of the solid oxide fuel cell 1 becomes difficult. Therefore, the separators 10 and 50 are preferably configured such that the channels 12a and 52a are narrowed stepwise in one to ten steps.

### Third Embodiment

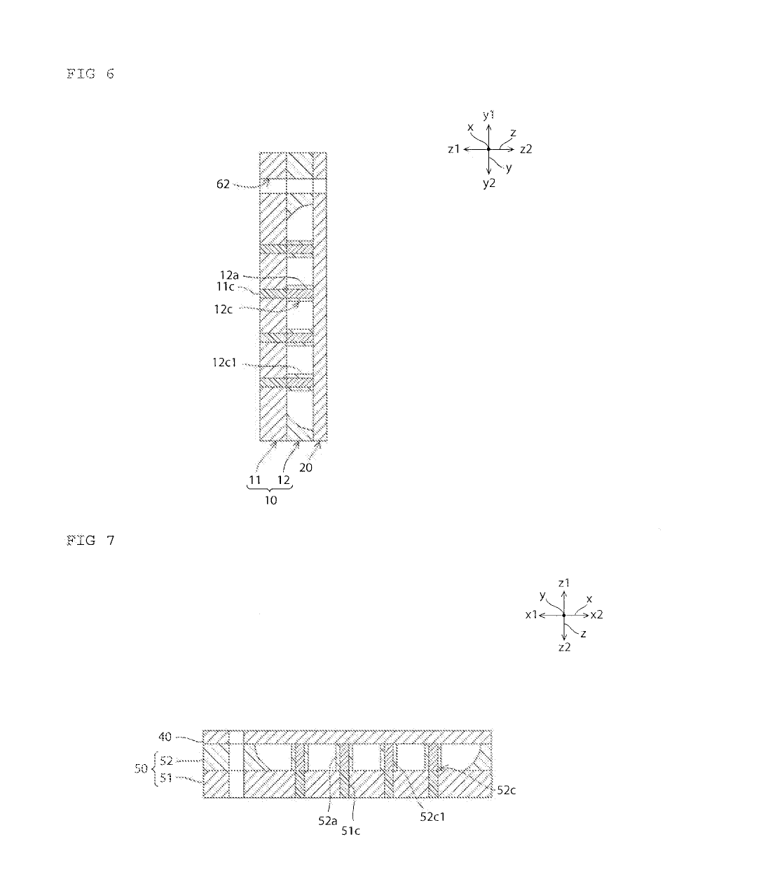

FIG. 6 is a schematic sectional view, along y and z directions, of a part of a fuel cell according to the third embodiment. FIG. 7 is a schematic sectional view, along x and z directions, of a part of the fuel cell according to the third embodiment. In FIGS. 6 and 7, the power generating element 30, the second porous body 40 and the second separator 50 are omitted because they are substantially the same as those of the solid oxide fuel cell 1 according to the first embodiment.

As shown in FIGS. 6 and 7, the separators 10 and 50 in this embodiment are configured such the widths of the channels 12a and 52a continuously decrease. By doing so, a situation in which stress is concentrated on specific areas of the separators 10 and 50 can be further effectively suppressed. Therefore, the separators 10 and 50 are hard to crack, so that further high power generation efficiency can be achieved, and a further high yield can be achieved.

### DESCRIPTION OF REFERENCE SYMBOLS

1 . . . solid oxide fuel cell
10 . . . first separator
11 . . . first separator body
11c . . . via hole electrode
12 . . . first channel forming member
12a . . . oxidant gas channel
12c . . . linear projection
12c1 . . . via hole electrode
20 . . . first porous body
30 . . . power generating element
31 . . . solid oxide electrolyte layer
32 . . . air electrode layer
32a . . . air electrode
33 . . . fuel electrode layer
33a . . . fuel electrode
40 . . . second porous body
50 . . . second separator
51 . . . second separator body
51c . . . via hole electrode
52 . . . second channel forming member
52a fuel gas channel
52c . . . linear projection
52c1 . . . via hole electrode
61 . . . manifold for oxidant gas
62 . . . manifold for fuel gas

1. A fuel cell comprising: a power generating element having a solid oxide electrolyte layer, a fuel electrode arranged on one principal surface of the solid oxide electrolyte layer, and an air electrode arranged on the other principal surface of the solid oxide electrolyte layer;
a first separator arranged on the air electrode and having an oxidant gas channel for supplying an oxidant gas to the air electrode; and
a second separator arranged on the fuel electrode and having a fuel gas channel for supplying a fuel gas to the fuel electrode,
wherein the width of the oxidant gas channel of the first separator decreases with distance from the air electrode, and
the width of the fuel gas channel of the second separator decreases with distance from the fuel electrode.

2. The fuel cell according to claim 1, wherein at least one of the first and second separators has linear projections which divide the oxidant or fuel gas channels, respectively, into a plurality of partitions in the width direction.

3. The fuel cell according to claim 2, wherein the width of the oxidant gas channel of the first separator decreases stepwise with distance from the air electrode, and the width of the fuel gas channel of the second separator decreases stepwise or continuously with distance from the fuel electrode.

4. The fuel cell according to claim 3, wherein the first separator has linear projections which divide the gas channel into a plurality of partitions in the width direction.

5. The fuel cell according to claim 3, wherein the first separator linear projections comprise a plurality of via hole electrodes.

6. The fuel cell according to claim 3, wherein the second separator has linear projections which divide the gas channel into a plurality of partitions in the width direction.

7. The fuel cell according to claim 6, wherein the second separator linear projections comprise a plurality of via hole electrodes.

8. The fuel cell according to claim 3, wherein the first and second separator have linear projections which divide the gas channels into a plurality of partitions in the width direction.

9. The fuel cell according to claim 8, wherein the linear projections comprise a plurality of via hole electrodes.

10. The fuel cell according to claim 2, wherein the width of the oxidant gas channel of the first separator decreases continuously with distance from the air electrode, and the width of the fuel gas channel of the second separator decreases stepwise or continuously with distance from the fuel electrode.

11. The fuel cell according to claim 10, wherein the first separator has linear projections which divide the gas channel into a plurality of partitions in the width direction.

12. The fuel cell according to claim 11, wherein the first separator linear projections comprise a plurality of via hole electrodes.

13. The fuel cell according to claim 10, wherein the second separator has linear projections which divide the gas channel into a plurality of partitions in the width direction.

14. The fuel cell according to claim 13, wherein the second separator linear projections comprise a plurality of via hole electrodes.

15. The fuel cell according to claim 10, wherein the first and second separator have linear projections which divide the gas channels into a plurality of partitions in the width direction.

16. The fuel cell according to claim 15, wherein the linear projections comprise a plurality of via hole electrodes.
